(19) United States
(12) Patent Application Publication
(10) Pub. No.: US 2006/0180960 A1
(43) Pub. Date: Aug. 17, 2006

(54) Method for surface treatment of clay, ceramic or cementitious articles

(76) Inventors: Thomas Munch-Laursen, Tommerup (DK); Lars Pedersen, Hjoerring (DK)

Correspondence Address: BANNER & WITCOFF, 1001 G STREET N W, SUITE 1100, WASHINGTON, DC, 20001, US

(21) Appl. No.: 10/513,449

(22) PCT Filed: May 3, 2003
(86) PCT No.: PCT/EP03/04901

§ 371 Date: Mar. 15, 2006

(30) Foreign Application Priority Data
May 9, 2002 (GB) 0210566.6

(51) Int. Cl. C04B 33/34

(52) U.S. Cl. 264/600

(57) ABSTRACT

A method for the surface treatment of clay, ceramic or cementitious articles, especially roofing tiles, comprising providing a hardenable, water-containing mass (1) shaped in the form of the article, then covering an exposed surface area of the article with a vibratable plate (3), for example of steel or acrylic, having an upper-surface and a smooth under-surface, such that the latter is in intimate contact with and conforms to the contours of that surface area of the article, thereby providing a plate-covered area of the article, vibrating the plate-covered area of the article, for example via a vibrator head (6), such that vibration is transmitted through the plate, to the surface of the article, and either removing the plate then hardening the article, or at least partially hardening the article with the plate in place.

This invention relates to a method for the surface treatment of clay, ceramic or cementitious articles, particularly roofing, floor and wall tiles, roofing panels and wall cladding panels. The method increases the smoothness, and can increase the density and hardness, of surfaces of such articles, thereby producing a glaze effect and increasing resistance to water penetration and to mould, moss or algae growth.

### BACKGROUND OF THE INVENTION

Tiles for flooring, roofing or wall cladding are commonly made from clay or concrete, but can also be made from cement paste with a high loading of fibres, especially glass fibres. The latter are often formed as panels, larger in area than normal roofing tiles of clay or concrete.

Concrete tiles are produced in an extrusion process, wherein an extrudable, concrete mass is extruded as a ribbon and is passed through elements of the manufacturing apparatus which press, mould and cut the sheet into individual roofing tile format. Clay tiles are usually produced in a pressing process, the clay mass being pressed into moulds to form and shape the tiles. After extrusion or pressing, the tiles are then hardened, usually by accelerated curing methods involving heat.

The surfaces of conventionally produced tiles tend to be somewhat rough and porous, and susceptible to scratching, especially in the case of concrete tiles. Porosity is undesirable because it affects the surface smoothness and results in water penetration, which carries the risk of degradation of the tile in freeze-thaw conditions, and makes the surface susceptible to moss, mould and algae growth, which is unsightly, and in the case of moss can lead to degradation of the tile. The surfaces of the tile are vulnerable to these adverse effects of water deposited on the weather exposed surface through rainfall, humidity, fog and the like, and on the interior facing surfaces through condensation. To reduce the roughness and porosity, and to improve the appearance of the tiles they are often glazed by either applying silicate frits to the surface and firing at high temperature or by painting with a hardenable lacquer prior to curing.

It would therefore be desirable to improve tile processing to reduce surface roughness and porosity, and to impart an aesthetically pleasing smooth appearance to the tiles without the necessity and additional expense of a separate lacquering step. Other articles of clay, and concrete, for example pipes, guttering, ornamental panelling and paving and the like would also benefit from such processing improvement. Ceramic articles too, such as wall and floor tiles could also benefit.

### BRIEF DESCRIPTION OF THE INVENTION

The present invention is based on the finding that the surface smoothness, and in many cases the surface density and hardness, of clay, ceramic and cementitious articles may be increased by applying a smooth side of a vibratable plate to an exposed surface of the unhardened article, and vibrating the surface of the article covered by the plate. Surface vibration has the effect of modifying the packing characteristics of the particles at the surface, increasing the density, and homogeneity of particles in the surface layer of the mass, to a depth which varies according to the composition of the mass, and the frequency, amplitude and duration of the vibration. After vibration, the plate may be separated from the article prior to or after partial or substantially complete hardening. Preferably, the article is hardened or partially hardened with the plate in place and the plate is subsequently separated from the surface of the article, to expose the smoothed surface.

Application of vibration to the surface of uncured concrete mixes has been used and proposed as a means of compacting the mass to varying depths, the compacted layer having a higher density and greater hardness than the uncompacted layer. Such proposals have usually been made in the context of surface compaction and finishing of floors. However, known methods have involved direct contact between the means of vibration and the concrete surface. Vibration of a clay or cementitious surface via a smooth surface of a vibratable plate which is in intimate contact with an exposed surface does not appear to have been used or proposed.

Furthermore, the value of vibrational surface treatment specifically in tile production does not seem to have been recognised despite the long standing availability of vibration techniques in the concrete art generally. For example, the normal way to decrease surface porosity and roughness of tiles has been to apply a glaze, which is expensive and adds an additional step to the manufacturing process.

### DETAILED DESCRIPTION OF THE INVENTION

According to the invention, there is provided a method for the surface treatment of a clay, ceramic or cementitious article comprising (i) providing a hardenable, water-containing clay, ceramic or cementitious mass shaped in the form of the article, (ii) covering an exposed surface area of the article with a vibratable plate having an upper-surface and a smooth under-surface, such that the latter is in intimate contact with and conforms to the contours of that surface area of the article, thereby providing a plate-covered area of the article, (iii) vibrating the plate-covered area of the article, such that vibration is transmitted through the plate, to the surface of the article, and (iv) either removing the plate then hardening the article or at least partially hardening the article with the plate in place.

The Mass to be Surface Treated

The method of the invention is applied to a hardenable, water-containing clay, ceramic or cementitious mass shaped in the form of the desired article. The article may be pressed or otherwise moulded from clay or ceramics material, or formed from a cementitious mass such as concrete or fibre-loaded cement paste by extrusion, rolling, pressing or a combination of such techniques. The water content of the mass to be treated by the method of the invention is not critical, but is preferably as low as possible, consistent with the shaping and handling requirements of the particular article. Clay and cementitious articles are hardenable at ambient or elevated temperatures, or by microwave irradiation. Ceramic articles are hardenable by firing at high temperatures. Articles to which the invention is particularly applicable include, floor, wall and roofing tiles, as well as roofing and wall cladding panels, and drainage pipes.

In the case of concrete tiles, especially roofing tiles, the shaped mass to which the method of the invention is applied will normally be provided by the pre-curing production stages of a conventional tile production process. In such processes, a mouldable, eventually hardenable mass comprising at least water and reactive binder particles, the latter including at least cement particles, is extruded from an extrusion orifice onto conveyor means adapted to carry the extruded mass as a ribbon away from the extrusion orifice. The ribbon has a lower surface in contact with the conveyor means and an upper surface, and is passed under a compacting and smoothing plate (known as a “slipper” or “glitter”), the lower surface of which contacts the upper surface of the ribbon across its width as it is conveyed under the plate by the conveyor means. The plate is positioned such that the extruded ribbon is pinched between the lower plate surface and the conveyor means as it passes under the plate, thereby compacting the ribbon and smoothing its upper surface as it slides in contact with the lower plate surface. The pressed, smoothed ribbon is then cut across its width into individual tile format. Usually, the conveyor means is a conveyor belt provided with a plurality of longitudinally closely adjacent pallets or moulds of individual tile dimensions onto which the ribbon is extruded, and the ribbon is cut into individual tiles across its width between adjacent pallets of moulds.

The method of the invention can be applied to conventional concrete tile mixes, based on cement particles, sand and water. However, good results are often obtained when the composition also includes microsilica powder, for example fly ash or silica fume, whose incorporation into the mix may be aided by a surfactant. Fibres of steel, glass or plastics material such as polyethylene may also be included. Best results will generally be obtained when the particle sizes of the cement, sand and microsilica are selected for dense packing, for example where the sand has a volume average particle size in the range 0.1 mm to 10 mm (or where two or more grades of sand are used, each grade has a volume average particle size in that range) and the microsilica powder has a volume average particle size in the range 0.001 μm to 100 μm, (or where two or more grades of microsilica are used, each grade has a volume average particle size in that range). Fibres of length 3 mm to 100 mm are useful for increasing toughness.

The Vibratable Plate

The vibratable plate is applied directly onto an exposed surface of the article, ie a pre-formed surface of the article which is openly accessible to the covering plate. Surfaces of the article which are in contact with supporting substrates are not exposed surfaces in this sense, nor are surfaces which are formed by casting the article in direct contact with a vibratable substrate.

The plate which covers the exposed surface of the shaped mass should be stiff and/or rigid enough to be vibrated and transmit that vibration to the surface of the article which it covers. It should have a smooth under-surface which is contoured, so that it may be laid in intimate contact with and conforming to the contours of the area of the surface of the article which it is to cover. Air bubbles between the plate and the article surface are preferably avoided. Steps may be taken, if desired, to reduce the air content of the article before applying the plate, for example by vibrating the article or by vacuum de-gassing. The surface smoothness of the article after vibration in accordance with the invention is in part a function of the smoothness of the plate undersurface. This follows because vibration causes the particles in the surface layer of the mass to be agitated into increasingly intimate contact with the plate under-surface, so that the surface characteristics of the article mirror those of the plate under-surface to a large extent.

Preferably, the plate has low adhesion affinity for the clay or cementitious mass of the article, so that it may eventually be separated from the article, which has preferably been hardened or partially hardened, without significant damage to the article surface. Vibratable plates for use in the invention include plastics plates, for example of acrylic resin materials, and metal plates such as steel plate. The undersurface of the plate may be polished, or coated or plated with a bright metal, for example by vapour deposition or electrodeposition, to improve surface smoothness. The hardening process for some articles may involve heating in an oven, and in such cases it will of course be desirable to choose a plate material which is compatible with the hardening temperature and duration, or to separate the plate from the article prior to exposure to the hardening temperature.

For tile production, the surface to be treated in accordance with the invention will normally be the upper surface, i.e. the surface which is visible when the tile is in use, although the invention can also be applied on both surfaces of the tile if required. For roofing tiles, the nose, ie the bottom edge of the tile is also visible, and the surface of that edge may benefit from treatment. Hence, the vibratable plate may be sized at least to cover the upper tile surface and extend over the edge of the tile to contact the bottom edge surface. In a production process, the plate covers may be dispensed onto the tiles from a stockpile.

Surface Vibration Through the Plate

Conveniently, the surface of the article is vibrated through the plate by pressing a vibrating head element into intimate contact with an area of the plate-covered area of the article, and causing the head element to vibrate while maintaining pressure contact between it and the plate-covered area of the article, such that vibration is transmitted through the vibratable plate element to the surface of the article. Thereafter contact between the head element and the plate-covered surface of the article is broken and the plate is separated from the article or, preferably, the article is at least partially hardened with the plate in place.

By causing relative movement between the vibrating head element and the plate-covered area of the article, the vibrating head element traverses a desired area of the plate. Since most tiles are rectangular in configuration, the vibratable plate element may also be rectangular with uniform transverse cross sectional profile, matching the contours of the upper tile surface In such cases, the vibrating head element may be contoured to match that profile, and the head may be caused to move longitudinally relative to the plate.

The axis or main axis of vibration of the vibratable plate may be perpendicular to the plane of the plate, but the vibration may also have components in other directions. Surface improvements are often obtained when vibration of a frequency of at least 150 Hz is transmitted from the vibratable plate element to the surface of the article. However, the frequency, amplitude and duration of the vibration may vary within wide ranges. Optimum parameters will be selected according to such factors as the composition of the mass being treated; the depth to which it is desired to influence the surface of the mass; the degree of surface glaze required on the finished article; and whether the production process for the article is a batch process or a continuous process. Good surface effects are often obtained when the vibratable plate is vibrated at ultrasonic frequencies, for example in the range 15 kHz to 50 kHz, or 20 kHz to 35 kHz, or using a combination of first mechanical vibration for example in the range of 100 Hz to 800 Hz and then vibration at ultrasonic frequency. The amplitude of vibration of the vibratable plate may be in the range 1 mm to 3μ. In one embodiment of the invention, the vibratable plate is alternately vibrated at two or more different frequencies and/or amplitudes.

As foreshadowed above, the frequency and amplitude of the vibration of the vibratable plate and the duration of the vibration may be selected to increase the surface density of the article, relative to its density prior to vibration, to a depth of at least 0.5 mm, or at least 1 mm, or at least 2 mm.

In the case of the continuous production of concrete tiles referred to above, i.e. by extrusion as a ribbon onto moulds carried on a conveyor belt, followed by cutting between moulds into individual tile format, the speed of production is conventionally relatively high, for example of the order of 100-150 tiles per minute. The speed of a single cycle of plate application and vibrational surface treatment may be too slow to be performed on each tile sequentially on a single conveyor belt. Hence, in one embodiment of the invention, he conveyor means divides into a plurality of tracks after the ribbon is cut into individual tiles. Tiles queued on the conveyer are successively transported onto separate tracks for the application of the vibratable plate and the vibrational treatment of each tile at individual stations associated with each track. The tracks recombine thereafter to reconstitute the queue of now plate-covered tiles for transport to hardening.

Hardening

After vibrational treatment in accordance with the invention, the vibratable plate is removed or, preferably, the article is at least partially hardened with the plate still in place. The latter is preferable because attempting to separate the plate from the surface of the article immediately after the vibrational treatment may disturb the smoothness of the still unhardened surface to some extent (though this may be minimised by careful removal of the plate and by choice of plate and article surface characteristics which minimise adhesion of the plate to the surface of the article). Surface smoothness damage is increasingly less likely as the article hardens. In addition, the plate protects the treated surface from handling damage during the further processing of the tile. In fact, it may be desirable in the case of tile manufacture to keep the plate in place until final palleting, or even to the point of end use, for this very reason.

In the case of tiles formed from Portland cement compositions without curing accelerators, the plate may stay in place on the tile surface for several hours, e.g. at least 6 hours, during partial curing of the tiles. At that point the plate may be separated from the tiles, or left in place during complete curing and storage of the tiles, only to be removed at the point of end use.

Special Effects

In accordance with another aspect of the invention, a dry, particle-containing composition may be applied to the surface of the article prior to its being covered by the vibratable plate. The vibrational treatment then causes the particles of that composition to become embedded in the vibrated surface of the article. Particles such as colour pigment, metal, or polymer particles may be incorporated in this way.

In another embodiment of the invention, the vibrational treatment may be utilised for the secondary purpose of impressing a pattern on the vibrated surface of the article. For example, a relief-pattern may be formed on the contact surface of the vibratable plate, such that when the vibratable plate is pressed into contact with the plate-covered area of the article and/or vibrated the relief pattern impresses the surface of the article.

The principles of the invention will now be further discussed by reference to the following Drawings, wherein

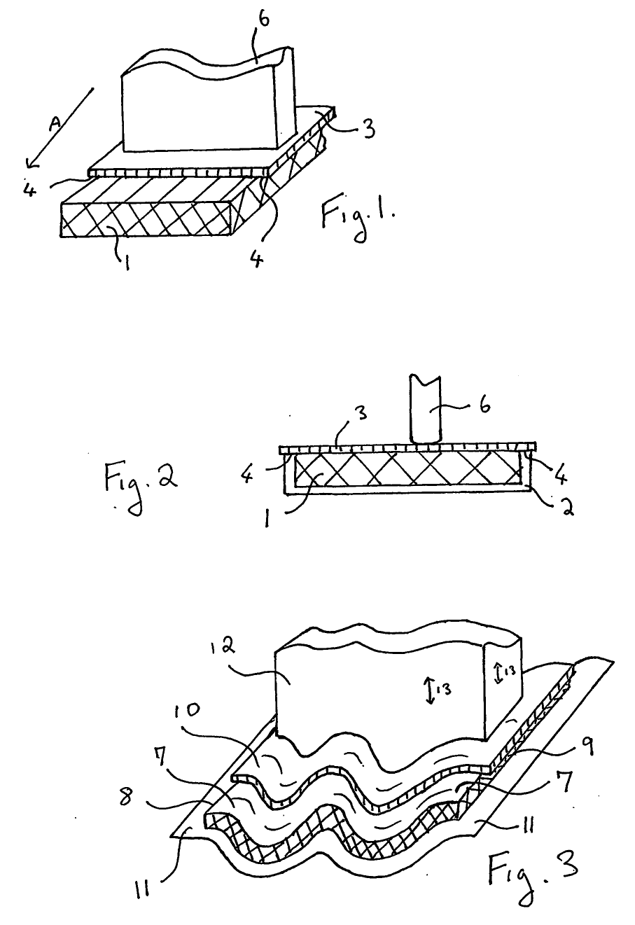

FIG. 1 is a perspective view of an assembly of a tile mass with a vibratable plate in contact with the tile, and a vibrator head in pressure contact with the plate.

FIG. 2 is a longitudinal cross-sectional view of the assembly of FIG. 1.

FIG. 3 is a perspective view of a tile mass having an S-profile, in contact with a contoured vibratable plate, and vibrator head.

Referring to FIGS. 1 and 2, an unhardened water-containing clay or cementitious mass 1 is moulded in mould 2 (shown in FIG. 2, but omitted for clarity in FIG. 1) into the form of a plain, generally flat roofing tile. A vibratable plate of steel 3 having a thickness of about 1 mm covers the upper surface of the tile and lies in intimate contact with that surface. The plate has a smooth polished undersurface in contact with the tile mass 1, and is sized to cover the tile, or to cover it with marginal overhangs 4. A resiliently mounted vibrator head 6 of the same width as the tile, vibrating at about 20 kHz mainly in the plane perpendicular to the plane of the plate-covered tile mass, is pressed into contact with the upper surface of the plate. The vibrator head is movable, while still in pressure contact with the plate-covered tile mass, in the direction indicated by arrow A, to traverse the entire length of the plate.

After the vibrating head has traversed the length (and thus the area) of the plate 3, that process being optionally repeated as many times as desired, the head is lifted out of contact with the plate. The plate-covered tile mass, still in its mould 2, is then transported to be at least partially hardened at ambient temperature, or in an oven. The tile may be demoulded when sufficiently hardened or after full hardening. The plate may be removed from the upper surface of the tile after partial hardening and before demoulding, or after hardening and demoulding, or later.

The principles of the invention, illustrated in relation to a flat roofing tile in FIG. 1, are equally applicable in the case of a profiled roofing tile as in FIG. 3. In FIG. 3, an unhardened water-containing cementitious mass 7 is shaped on a mould 11 into the form of an S-profiled roofing tile. (In practice the tile would have longitudinal grooves on the underside of edge 8 and corresponding longitudinal mating grooves on the upperside at edge 9, so that when two adjacent tiles are laid side by side upperside grooves of one interlock with the underside grooves of the other. Likewise, there would be grooves on the underside at the bottom edge of the tile and corresponding interlocking grooves on the upperside at the top edge, to interlock tiles laid one above the other in adjacent courses on a roof. These grooves have been omitted from FIG. 3 for clarity).

As in FIGS. 1 and 2, a steel or acrylic plate 10, shown partially cut away, has the same S-profile as the tile and has been applied to the upper surface of the tile and lies in intimate contact with that surface. Again the plate has a smooth undersurface in contact with the tile mass 7, and is sized slightly larger in area than the area of the tile plus perimeter mould wall. A resiliently mounted vibrator head 12 of the same width as the plate 10 is pressed into contact with the upper surface of the plate 10, and vibrates principally in the direction indicated by arrows 13. The vibrator head is also contoured to match the S-profile of the plate and, like that of FIGS. 1 and 2, is movable longitudinally over the plate while still in pressure contact therewith.

As an alternative to the embodiments of FIGS. 1-3, the vibrator head could be resiliently mounded for pressure contact with the plate 3 or 10, and arranged to traverse the plate across its width, rather than along its length as in FIGS. 1-3. In that case, the head need not be S-profiled as in FIG. 3.

1. A method for the surface treatment of a clay, ceramic or cementitious article comprising (i) providing a hardenable, water-containing clay, ceramic or cementitious mass shaped in the form of the article, (ii) covering an exposed surface area of the article with a vibratable plate having an upper-surface and a smooth under-surface, such that the latter is in intimate contact with and conforms to the contours of that surface area of the article, thereby providing a plate-covered area of the article, (iii) vibrating the plate-covered area of the article, such that vibration is transmitted through the plate, to the surface of the article, and (iv) either removing the plate then hardening the article, or at least partially hardening the article with the plate in place.

2. A method as claimed in claim 1 wherein the article is at least partially hardened with the plate in place, and the plate is separated from the article subsequently to said at least partial hardening.

3. A method as claimed in claim 1 wherein the vibratable plate is vibrated by contacting a vibrating head element with the side of the plate not in contact with the article, and causing relative movement between the head element and the contacted plate-covered area of the article, such that the vibrating head element traverses a desired area of that side.

4. A method as claimed in claim 43 wherein the vibratable plate element is rectangular with uniform transverse cross sectional profile, the vibrating head element is contoured to match that profile, and the head is caused to move longitudinally relative to the plate.

5. A method as claimed in claim 1 wherein the axis or main axis of vibration of the plate-covered surface area of the article is generally perpendicular to that surface area.

6. A method as claimed in claim 1 wherein vibration of a frequency of at least 150 Hz is transmitted through the plate, to the surface of the article.

7. A process as claimed in claim 1 wherein the frequency and amplitude of the vibration and the duration of the vibration are selected to increase the surface density of the article, relative to its density prior to vibration, to a depth of at least 0.5 mm.

8. A process as claimed in claim 1 wherein the frequency and amplitude of the vibration and the duration of the vibration are selected to increase the surface density of the article, relative to its density prior to vibration, to a depth of at least 1 mm.

9. A process as claimed in claim 1 wherein the frequency and amplitude of the vibration and the duration of the vibration are selected to increase the surface density of the article the surface density of the article, relative to its density prior to vibration, to a depth of at least 2 mm.

10. A process as claimed in claim 1 wherein the vibration transmitted through the plate has a frequency in the range 15 kHz to 50 kHz.

11. A process as claimed in claim 1 wherein the vibration transmitted through the plate has a frequency is in the range 20 kHz to 35 kHz.

12. A process as claimed in claim 1 wherein the vibration transmitted through the plate has an amplitude in the range 1 mm to 3μ.

13. A process as claimed in claim 1 wherein the vibration transmitted through the plate varies in frequency and/or amplitude.

14. A method as claimed in claim 1 wherein a dry, particle-containing composition is applied to the surface of the article prior to its being covered by the vibratable plate.

15. A method as claimed in claim 14 wherein the particles in the particle-containing composition are color pigment, metal, or polymer particles.

16. A method as claimed in claim 1 wherein a relief pattern is formed on the contact surface of the vibratable plate such that when the vibratable plate is pressed into contact with the of the article and/or vibrated the relief pattern impresses the surface of the article.

17. A method as claimed in claim 1 wherein the article is a roofing tile, a wall tile, a floor tile, a roofing panel, a pipe or a wall cladding panel.

18. A method as claimed in claim 1 wherein the article is a shaped cementitious mass containing cement particles and microsilica particles as reactive binder particles.

19. A method as claimed in claim 18 wherein the cementitious mass contains sand.

20. A method as claimed in claim 1 wherein particles of size greater than 5 mm constitute less than 0.1% by weight of the weight of particles in the article.

21. A method as claimed in claim 1 wherein the article is a shaped cementitious mass and in step (i) the volume ratio of water to cement and other reactive binder particles, if present, is in the range 0.15-0.23.

22. A method as claimed in claim 1 for production of cementitious tiles for roofing or wall cladding, wherein in step (i) a hardenable water-containing cementitious mass shaped in the form of a roofing or wall cladding tile is provided by (a) providing a moldable, eventually hardenable mass comprising at least water and reactive binder particles, the latter including at least cement particles, (b) extruding the mass from an extrusion orifice onto conveyor means adapted to carry the extruded mass as a ribbon away from the extrusion orifice, (c) the ribbon having a lower surface in contact with the conveyor means and an upper surface, (d) passing the ribbon under a compacting and smoothing plate, the lower surface of which contacts the upper surface of the ribbon across its width as it is conveyed under the plate by the conveyor means, (e) the plate being positioned such that the extruded ribbon is pinched between the lower plate surface and the conveyor means as it passes under the plate, thereby compacting the ribbon and smoothing its upper surface as it slides in contact with the lower plate surface, and (f) cutting the pressed, smoothed ribbon across its width into individual tile format.

23. A method as claimed in claim 22 wherein the conveyor means is provided with a plurality of longitudinally closely adjacent pallets or molds of individual tile dimensions onto which the ribbon is extruded, and the ribbon is cut into individual tile format across its width between adjacent pallets or moulds.

24. A method as claimed in claim 23 wherein in step (ii) the exposed upper surface each cut tile format is covered with a vibratable plate.

25. A method as claimed in claim 22 wherein the conveyor means divides into a plurality of tracks after the ribbon is cut into individual tiles, individual tiles queued on the conveyer are successively transported onto separate tracks for the performance of steps (ii) to (iv) on each individual tile, and the tracks recombine thereafter to reconstitute the queue of now plate-covered tiles.
